(19) United States
(12) Patent Application Publication
(10) Pub. No.: US 2025/0252206 A1
(43) Pub. Date: Aug. 7, 2025

(54) Object Permissions Management

(71) Applicant: Varonis Systems Inc., New York, NY (US)

(72) Inventors: Peter Shmukler, Netanya (IL); David Bass, Karmei Yosef (IL)

(21) Appl. No.: 18/435,542

(22) Filed: Feb. 7, 2024

(51) Int. Cl. G06F 21/62; G06F 21/60

(52) U.S. Cl. CPC G06F 21/6227; G06F 21/604

(57) ABSTRACT

A denormalised database structure and access methodology to allow efficient querying of permissions data and visualisation of permissions data.

### TECHNICAL FIELD

The following disclosure relates to a system for managing object permissions in a computer system.

### BACKGROUND

Computer systems store a very large number of objects, typically files and folders, which can be accessed by users of the computer systems. The computer maintains a record of permissions applicable to each object to indicate what access each user has. If a user has access to an object there are a number of types of access that may be provided, for example read-only or read and write.

The large number of objects in a computer system and the large number of users (who are typically arranged into hierarchical groups with permission inheritance) lead to a large data set to represent the permissions. Typically permissions are stored in a relational database with a configuration optimised for identifying the permissions applicable to a given object. That is, the relational database can efficiently determine which users have what permissions for a given object.

It is important that permissions within a computer system are managed carefully to ensure the correct access is available to each user. If that is not the case users can obtain access to objects they should not be able to see, or could accidentally (or even deliberately) amend or delete objects that they should not be able to.

In order to manage permissions it is helpful to be able to search permissions by user (or user group) to identify what permissions a particular user or group of users has and verify whether they are correct. However, although the relational database is efficient when starting from objects, it is significantly less efficient when starting from users, or combinations of users and objects. This is because the many-to-many relationship from objects to users means requesting records for a user can yield a very large number of results.

In order to review effective permissions to verify and manage them users must be able to visualise permissions for user/object pairs to identify applicable permissions and whether they are correct. For example, an administrator may start with a filter for folders containing a certain key word, such as “Finance”, and request details for groups of users such as “Domain Users”. The administrator may then narrow down the search to more specific groups of users and folders. However, generating the required data for such user/object pairs is computationally expensive, and many searches will likely generate such large data sets that they are impractical or even impossible for the computer system to return.

It is not unusual for a computer system to contain 1 billion objects, and in a poorly managed system a set of 100,000 users and groups could have access rights of some kind. This would lead to a potential output of 1014 user/object pairs, which is effectively impossible for a system to output. This problem is not unique to permission management, but can also occur in systems managing events and messages.

There is therefore a requirement for an efficient system for managing permissions, in particular in relation to a computer system's ability to efficiently identify data based on user and object data.

### SUMMARY

The invention is defined by the following disclosure and the claims.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. Like reference numerals have been included in the respective drawings to ease understanding:

FIG. 1 shows a conventional database structure applicable to permission data storage;

FIG. 2 shows a partially non-normalised database structure applicable to permission data storage;

FIG. 3 shows a further de-normalised database structure applicable to permission data storage;

FIG. 4 shows an exemplary de-normalised permission data database structure;

FIG. 5 shows a flow chart of a process for querying data for permission visualisation; and

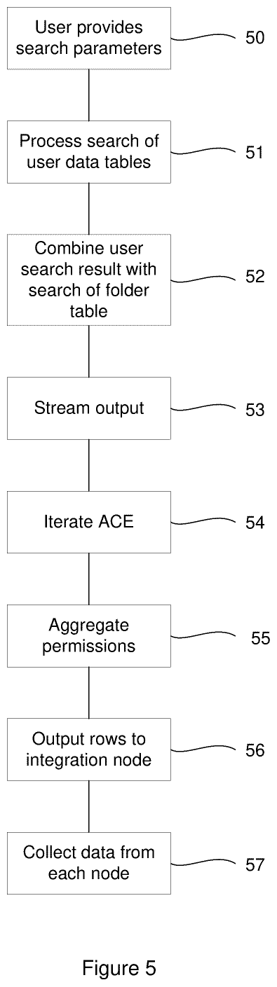

FIG. 6 shows an exemplary computing system.

### DETAILED DESCRIPTION

The present disclosure relates to improved data storage techniques, in particular for permission management.

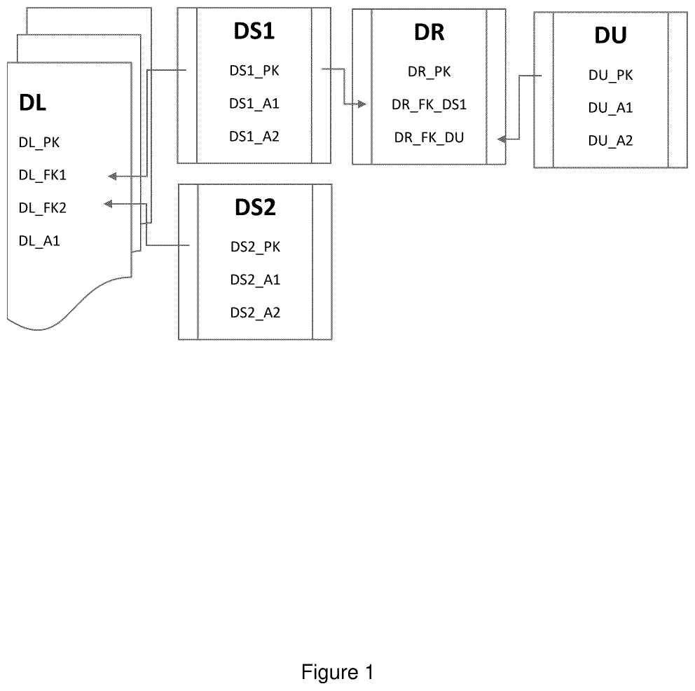

Permissions for object access in a computer system are typically held in a relational database system (RDBMS) which is optimised to return the permissions relating to an object in the database to allow the system to determine what access permissions a user has to that object. Typically such databases contain a data model with multiple tables structured according to the 3^{rd} normal form (3NF). FIG. 1 shows a generic RDBMS structure organised according to the 3NF in which one table (DL) is very large and may contain billions of records. For example, that table may represent objects (e.g. folders or files) in a computer system, events, or messages. The table has a unique key (DL_PK) to identify each record, which could be known as ObjectId, FolderID, EventID, or MessageID as appropriate.

Further tables of the data model may have one to many relations to the large table (DS1_PK→DL_FK), and attributes of that table (DS1_A1, DS1_A2, . . . ) can be used for filtering, in addition to attributes of DL (DL_A1, . . . ). In the example of FIG. 1, the DS1 table may represent groups of users, with membership of those groups represented by the DR and DU tables, each linked by appropriate primary and foreign keys as shown.

When a user accesses, or otherwise interacts with, an object the computer system identifies the object in the DL table, and then join the other tables to identify the relevant permissions. This query can be executed efficiently as despite DL being very large, the query is seeking only a single record which can then be joined to the smaller other tables.

However, in an example use of the RDBMS structure of FIG. 1 to visualise permissions, a user may request records with criteria including DL_A1, DS1_A1, and DU_A1, returning the top N DL items. Such a query may generate a very large number of results, and may not be executable due to the join structure which is optimised to start from a small number of DL objects. It may not be possible to build an execution plan based on statistics of DU_A1, and the join chain DU_PK→DR_FK_DU, DR_FK_DS1→DS1_PK, DS1_PK→DL_FK1. If the DL−DS1 relation has a low cardinality an extremely large transaction can result leading to blocking for extended periods of time, or outright failure of the query, even though only N records have been requested from DL. That is, the query execution first requires a very large data set to be prepared, which is then filtered to recover the N records. This exemplary data structure cannot therefore be used in a practical implementation to visualise permissions from the database structure of FIG. 1.

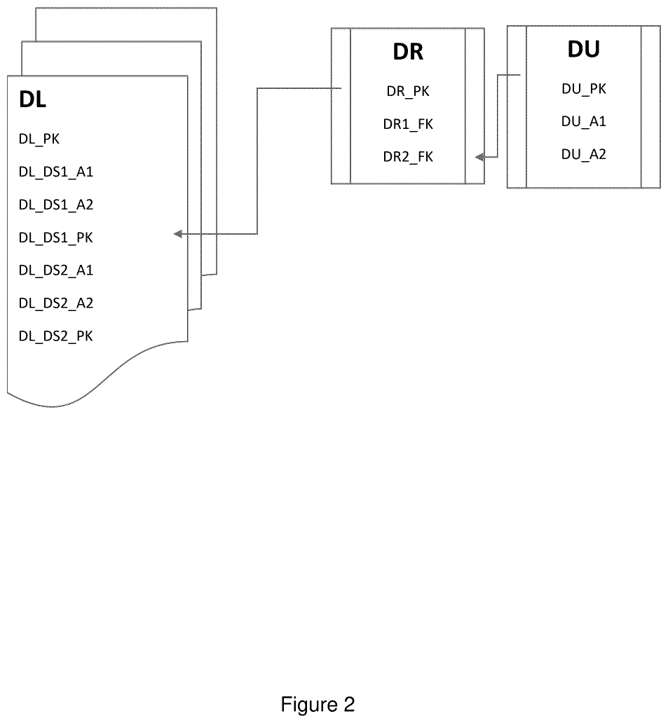

FIG. 2 shows a schematic diagram of a database structure to partially address the challenges outlined hereinbefore by utilising a mixture of RDBMS and streaming technology. In the structure of FIG. 2 a denormalization process has combined the DS1 and DS2 tables into the DL table which reduces the complexity of the joins, but leads to DL breaking the ⅔ NF normalisation principles because a plurality of lines duplicate aspects of the data (e.g. different rows of DS1 appear directly in DL, but with common elements).

To visualise permission data from the structure of FIG. 2, a filter can be applied to DU and joined with DR to generate an intermediate output including tuples of DU and the relevant DR_PK. This output can then be combined with rows in DL identified by filtering on DL_A1, DL_DS1_A1, etc. The rows output from filtering DL can be streamed to the user to avoid a very large single transaction. The structure of FIG. 2 provides for improved efficiency in querying the database, but with a trade-off that the size of the DL table increases.

In common applications the DR and DU tables are relative small and the full tables can be held in memory. This permits them to be quickly joined and filtered to generate the intermediate output.

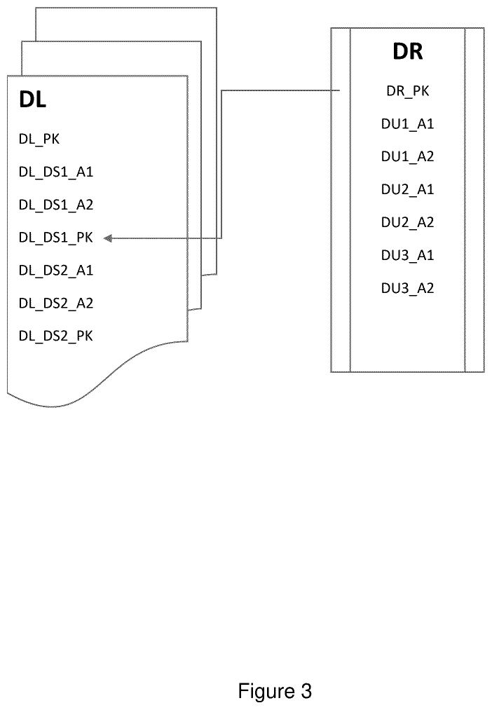

FIG. 3 shows the result of a further denormalization step to provide a further improvement in efficiency of querying the database. In FIG. 3 the DR and DU tables have been combined into a single table, which are joined to the DL table via DR_PK. The resulting structure does not comply with the 1NF principles, and the size of DL increases, but it enables a more efficient joining of DL and DR in order to search by criteria in both DL and DR. By using a streaming database (for example, SOLR (allows the use of a custom JOIN decorator)) technology the top N rows of DL, filtered based on DR, can be returned efficiently. The DR table is still relatively small and so can be held in memory to improve the efficiency of accessing that table.

The data structure of FIG. 3 addresses the problem of joining N tables by a field having low cardinality, which can be impossible to execute. The data structure of FIG. 3 allows querying of N−1 small tables, which data is preferably small enough to be stored in memory and hence can be accessed quickly. The result of this first step is used to filter the remaining table which is much larger, but a streaming technology is utilised to allow efficient output of the results without having to build the entire output data set in order to output a required number of results without locking the database system.

The query results can be used to provide additional search parameters to further restrict results and guide the user's analysis of the permissions. For example it is anticipated a set of 1000 folder/user pairs could be generate in less than a second. The output of that query can be used to further refine the query/filter to identify areas of interest.

A specific example of the above principles in relation to permission management may use 3 tables arranged according to the discussion hereinbefore. A first User and Group table contains user and group IDs and their names, for example comprising:—.

Users and Groups

| | |
|---|---|
| UserAndGroupID | Int32 |
| Name | text |

A second table contains the hierarchy of users and groups, for example:—

Users and Groups Hierarchy.

| | |
|---|---|
| UserAndGroupID | Int32 |
| ParentUserAndGroupID | Int32 |

These table are relatively small so can be cached in memory to allow fast access. For example, 100,000 users, an average group membership of 10, and a 4 byte ID leads to about 4 Mb of data, which can comfortably be stored in memory. Further techniques to represent users and groups, such as that disclosed by U.S. Pat. No. 9,641,334, can be utilised. That patent is incorporated by reference herein in its entirety, particularly in relation to the disclosure relating to the formation of virtual groups which may reduce the required storage capacity still further.

The above tables can be joined using UserAndGroupID, and these can be joined to a folders table, also using that ID. The folders table contains folder and path details as well as full permission details, joined to the above tables by the UserAndGroupID. This table is typically extremely large as firstly it represents a large number of objects, and secondly it is de-normalised such that it will contains relatively large amounts of repeated data, for the reasons discussed above. This table is most likely sharded uniformly across computation nodes (for example based on a hash of the path), and columnar storage can be utilised to minimise storage (which typically achieves in excess of 90% compression for path names)

Folders. Scaled out over the computation nodes

| | |
|---|---|
| FolderID | Int32 |
| Path | text |
| Permissions in the form: | JSON |
| [{ACE Type, ACE Mask, | |
| ACE Flag, ACE | |
| UserAndGroupID}, . . . .] | |
| PermitedUsersAndGroups | Int32, multiValued |
| UserAndGroupID, . . . | |

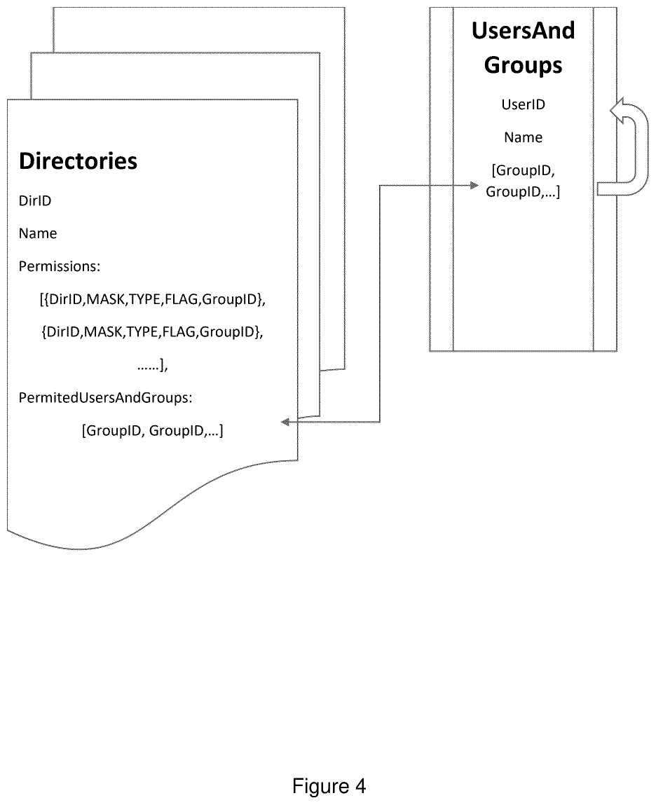

As will be appreciated the specific names and data types are given as examples only, and are not restrictive of the invention. The relationship of the key elements of these data structures is shown in FIG. 4. With reference to FIGS. 4 & 5, the following process enables querying of these data structures in an efficient manner to visualise permissions in a large computing system.

At step 50, a user wishes to review permissions according to specified search terms. For example, they may wish to review folders or files containing the word “finance” in relation to users indicated as guests, or who are part of groups such as “public”. In a conventional system such a query would require a complex execution strategy, and likely could not run effectively due to the need to generate the entire data set before selecting the first N results to output, which may be too large to handle.

At step 51 the processes the user-related search parameters. The system collects the UserAndGroupIDs of interest based on the user's search parameters (for example, public or guest) into memory. This step is efficient as the relevant tables are preferably held in memory at each node of the database due to their size. The search may be run recursively to work through the hierarchy of groups. The step may be run at each node of the database in parallel.

At step 52 the folder filter (contains “finance”) is combined a filter of PermittedUsersAndGroups in the folder table based on the UserGroupIDs identified in step 51.

At step 53 data from the above query is streamed as it is identified at each node, which avoids generating the entire data set. At step 54 the process iterates over each Access Control Element (ACE) in the permissions table, and collects leaf users inheriting permissions from each ACE group. The process then iterates over these collected users.

At step 55 the relevant ACEs are aggregated into permissions for specific users on specific folders.

At step 56 the desired number of output rows is counted, and the output rows returned to an integration node, and the request is closed.

As step 57 the output from each computation node is collected, any post-processing is performed, and the data is returned to the user.

Steps 53-56 are run in parallel on each node at which parts of the data are stored.

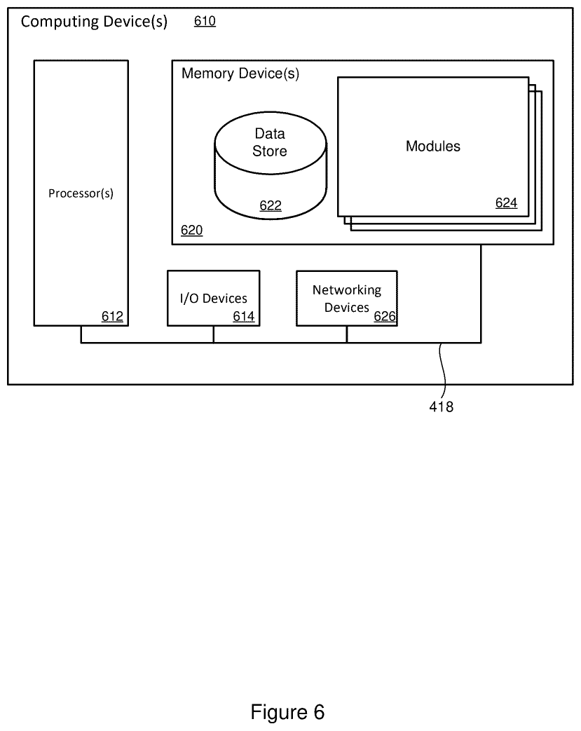

FIG. 6 illustrates a computing device 610 on which modules of this technology may execute. A computing device 610 is illustrated on which a high level example of the technology may be executed. The computing device 610 may include one or more processors 612 that are in communication with memory devices 620. The computing device 610 may include a local communication interface 418 for the components in the computing device. For example, the local communication interface 418 may be a local data bus and/or any related address or control busses as may be desired.

The memory device 620 may contain modules 624 that are executable by the processor(s) 612 and data for the modules 624. In one aspect, the memory device 620 may include a checkpoint manager, a migration management module, and other modules. In another aspect, the memory device 620 may include a network connect module and other modules. The modules 624 may execute the functions described earlier. A data store 622 may also be located in the memory device 620 for storing data related to the modules 624 and other applications along with an operating system that is executable by the processor(s) 612.

Other applications may also be stored in the memory device 620 and may be executable by the processor(s) 612. Components or modules discussed in this description that may be implemented in the form of software using high-level programming languages that are compiled, interpreted or executed using a hybrid of the methods.

The computing device may also have access to I/O (input/output) devices 614 that are usable by the computing devices. Networking devices 616 and similar communication devices may be included in the computing device. The networking devices 416 may be wired or wireless networking devices that connect to the internet, a LAN, WAN, or other computing network.

The components or modules that are shown as being stored in the memory device 620 may be executed by the processor(s) 612. The term “executable” may mean a program file that is in a form that may be executed by a processor 612. For example, a program in a higher level language may be compiled into machine code in a format that may be loaded into a random access portion of the memory device 620 and executed by the processor 612, or source code may be loaded by another executable program and interpreted to generate instructions in a random access portion of the memory to be executed by a processor. The executable program may be stored in any portion or component of the memory device 620. For example, the memory device 620 may be random access memory (RAM), read only memory (ROM), flash memory, a solid state drive, memory card, a hard drive, optical disk, floppy disk, magnetic tape, or any other memory components.

The processor 612 may represent multiple processors and the memory device 620 may represent multiple memory units that operate in parallel to the processing circuits. This may provide parallel processing channels for the processes and data in the system. The local interface 618 may be used as a network to facilitate communication between any of the multiple processors and multiple memories. The local interface 618 may use additional systems designed for coordinating communication such as load balancing, bulk data transfer and similar systems.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognise that various features of the described embodiments may be combined in accordance with the invention. In the claims, the term “comprising” or “including” does not exclude the presence of other elements. Similarly the use of the singular does not exclude the plural and vice-versa.

The term “computer” or “computing device” is used herein to refer to any computing device which can execute software and provide input and output to and from a user. For example, the term computer explicitly includes desktop computers, laptops, terminals, mobile devices, and tablets, as well as any similar or comparable devices. There is no intended difference between the terms computer, computing system or computing device, all of which fall within the same definition of computer.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable storage media or, more generally, a computer program product. The computer readable storage media, as the term is used herein, is not to be construed as storage in the form of transitory signals per se, such as radio waves or other freely propagating electromagnetic waves. The one or more computer readable storage media could be, for example, an electronic, magnetic, optical, electromagnetic, infrared, or semiconductor system, or a propagation medium for data transmission, for example for downloading the code over the Internet. Alternatively, the one or more computer readable storage media could take the form of one or more physical computer readable media such as semiconductor or solid state memory, magnetic tape, a removable computer diskette, a random access memory (RAM), a read-only memory (ROM), a rigid magnetic disc, and an optical disk.

What is claimed is:

1. A computer system for managing permissions, comprising:
a data storage system comprising computer readable storage media storing permissions data, the permissions data comprising a first non-normalised table comprising object and permission data, and at least a second table stored in memory containing user information, the first non-normalised table being joinable to the second table utilising an identifier;
one or more computer readable storage media storing program instructions and one or more processors which, in response to executing the program instructions, are configured to:
query the second table based on parameters provided by a user to generate a first interim data set;
query the first non-normalised table based on the first interim data set; and
stream the results from the query of the first non-normalised table to deliver a predefined number of results without an interim step of generating a full output set.

2. A computer system according to claim 1, wherein the first non-normalised table is sharded across a plurality of nodes.

3. A computer system according to claim 2, wherein the second table is stored in memory at each node and the step of querying the second table is performed at each node.

4. A computer system according to claim 1, wherein the first non-normalised table is also queried based on parameters provided by a user in relation to data stored in the first non-normalised table and not in the second table.

5. A computer system according to claim 1, wherein the user information represents users in a hierarchical structure.

6. A computer system according to claim 2, wherein data is collated from the plurality of nodes and transmitted to a user.

7. A computer-implemented method for managing permissions, comprising:
storing permissions data at a data storage system comprising computer readable storage media, the permissions data comprising a first non-normalised table comprising object and permission data, and at least a second table stored in memory containing user information, the first non-normalised table being joinable to the second table utilising an identifier;
by a processing system performing the steps of:
querying the second table based on parameters provided by a user to generate a first interim data set;
querying the first non-normalised table based on the first interim data set; and
streaming the results from the query of the first non-normalised table to deliver a predefined number of results without an interim step of generating a full output set.

8. A computer-implemented method according to claim 7, further comprising the step of sharding the first non-normalised table across a plurality of nodes.

9. A computer-implemented method according to claim 8, wherein the second table is stored in memory at each node and the step of querying the second table is performed at each node.

10. A computer-implemented method according to claim 7, wherein further comprising the step of querying the first non-normalised table based on parameters provided by a user in relation to data stored in the first non-normalised table and not in the second table.

11. A computer-implemented method according to claim 7, wherein the user information represents users in a hierarchical structure.

12. A computer-implemented method according to claim 8, further comprising the step of collating data from the plurality of nodes and transmitting the collated data to a user.
